(19) United States
(12) Patent Application Publication
(10) Pub. No.: US 2026/0186809 A1
(43) Pub. Date: Jul. 2, 2026

(54) SERVER MONITORING DEVICE, SERVER MONITORING SYSTEM, SERVER MONITORING METHOD, AND PROGRAM

(71) Applicant: Nippon Telegraph and Telephone Corporation, Tokyo (JP)

(72) Inventors: Katsumi FUJITA, Musashino-shi, Tokyo (JP); Masashi KANEKO, Musashino-shi, Tokyo (JP); Eriko IWASA, Musashino-shi, Tokyo (JP)

(21) Appl. No.: 18/855,485

(22) PCT Filed: May 10, 2022
(86) PCT No.: PCT/JP2022/019771

§ 371 Date: Oct. 9, 2024

(51) Int. Cl. G06F 9/455; G06F 1/324; G06F 11/30

(52) U.S. Cl. CPC G06F 9/45558; G06F 1/324; G06F 11/3024; G06F 2009/45591

(57) ABSTRACT

A controller (10) includes: a monitoring unit (1) that collects each piece of data of a physical server group including a plurality of physical servers (31) that implement a compute on which a virtual machine/container is mounted and monitors a status of each of the physical servers (31); a rule setting database (3b) in which a monitoring rule is set; and a monitoring frequency control unit (2) that updates a collection mode of each piece of data on the basis of the monitoring rule corresponding to the physical server (31) set in the rule setting database (3b), and periodically sets the frequency of data collection executed according to the monitoring rule.

### TECHNICAL FIELD

The present invention relates to a server monitoring device, a server monitoring system, a server monitoring method, and a program.

### BACKGROUND ART

In recent years, various services have been provided on service infrastructures. In providing services, a server monitoring function is essential.

In particular, a wide variety of virtualized applications (sometimes referred to as Apps) operate on a server infrastructure, and information necessary for controlling the applications with a controller is collected. For example, a data collection tool collects hardware information such as a usage rate of a central processing unit (CPU) on which an application is executed and an operating frequency of the CPU as necessary information. Some applications have internal configurations that are converted into black boxes.

Objects controlled by the controller include placement control of virtualized applications, setting and change of hardware and an operating system (OS), and the like. In addition, the application placement control corresponds to scale-in, scale-out, migration, and the like of a virtual machine (VM).

Here, in a case where a deployment request reaches the controller from an application executed in the virtualized environment, optimal component placement can be performed in the virtualized environment, and thus real-time monitoring is unnecessary (see Non Patent Literature 1).

On the other hand, when a service is operated on a service infrastructure, monitoring is performed at an arbitrary frequency, and optimal component placement and setting are dynamically performed (see Non Patent Literature 2 and Non Patent Literature 3).

### CITATION LIST

### Non Patent Literature

Non Patent Literature 1: Von Laszewski, Gregor, et al. “Power-aware scheduling of virtual machines in dvfs-enabled clusters.” 2009 IEEE International Conference on Cluster Computing and Workshops. IEEE, 2009.

Non Patent Literature 2: Rocha, Isabelly, et al. “Heats: Heterogeneity- and energy-aware task-based scheduling.” 2019 27th Euromicro International Conference on Parallel, Distributed and Network-Based Processing (PDP). IEEE, 2019. Non Patent Literature 3: Douhara, Ryuki, et al. “Kubernetes-based workload allocation optimizer for minimizing power consumption of computing system with neural network.” 2020 International Conference on Computational Science and Computational Intelligence (CSCI). IEEE, 2020.

### SUMMARY OF INVENTION

### Technical Problem

Non Patent Literature 2 and Non Patent Literature 3 do not disclose any specific method for determining the frequency of data collection. The contents in Non Patent Literature 2 and Non Patent Literature 3 disclose that no overhead occurs due to monitoring that affects the service at the time of evaluation.

However, when monitoring is performed, processing is performed in which dedicated software collects power, performance data, and the like in a server and transmits the collected data to an analysis unit or the like. In this way, the power of the server necessary for providing the service is consumed by the processing by dedicated software.

Therefore, the monitoring frequency, which indicates the frequency of data collection, is important in an environment that manages a service infrastructure in which a wide variety of applications are installed on hardware and a combination of the applications is dynamically changed.

The present invention has been made in view of such a point, and an object of the present invention is to suppress overhead and power consumption due to real-time monitoring on a service infrastructure in which a wide variety of applications are installed on hardware and a combination of the applications is dynamically changed.

### Solution to Problem

A server monitoring device according to the present invention includes: a monitoring unit that collects each piece of data of a physical server group including a plurality of physical servers that implement a compute on which a virtual machine/container is mounted and monitors a status of each of the physical servers; a rule setting database in which a monitoring rule indicating a frequency of data collection is set for each of the physical servers; and a monitoring frequency control unit that updates a collection mode of each piece of the data on the basis of the monitoring rule corresponding to the physical server set in the rule setting database, and periodically sets the frequency of data collection executed according to the monitoring rule.

### Advantageous Effects of Invention

According to the present invention, it is possible to suppress overhead and power consumption due to real-time monitoring on a service infrastructure in which a wide variety of applications are installed on hardware and a combination of the applications is dynamically changed.

### BRIEF DESCRIPTION OF DRAWINGS

FIG. 1 is an explanatory diagram illustrating a configuration of a server monitoring system according to the present embodiment.

FIG. 2 is an explanatory diagram illustrating a rule setting database stored in a database.

FIG. 3A is a flowchart illustrating a flow of processing of collecting data from a compute and determining a frequency at which a controller monitors the compute in the server monitoring system (part 1).

FIG. 3B is a flowchart illustrating a flow of processing of collecting data from a compute and determining a frequency at which a controller monitors the compute in the server monitoring system (part 2).

FIG. 3C is a flowchart illustrating a flow of processing of collecting data from a compute and determining a frequency at which a controller monitors the compute in the server monitoring system (part 3).

FIG. 4 is a flowchart illustrating a flow of App request processing.

FIG. 5 is a flowchart illustrating a flow of CPU usage rate determination processing.

FIG. 6 is a flowchart illustrating a flow of database rewriting processing.

FIG. 7 is a flowchart illustrating a flow of model construction processing.

FIG. 8 is a flowchart illustrating a flow of CPU allocation processing.

FIG. 9 is a hardware configuration diagram illustrating an example of a computer that implements functions of the controller according to the present embodiment.

### DESCRIPTION OF EMBODIMENTS

Hereinafter, embodiments of the present invention will be described with reference to the drawings.

### Present Embodiment

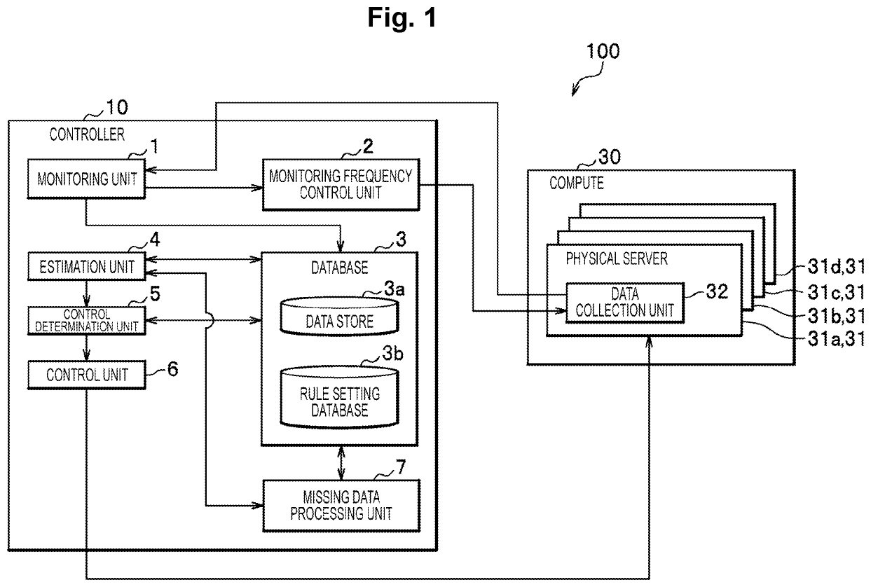

FIG. 1 is an explanatory diagram illustrating a configuration of a server monitoring system 100 according to the present embodiment.

As illustrated in FIG. 1, the server monitoring system 100 includes a controller 10 (server monitoring device) and a compute 30 (physical server group).

In the server monitoring system 100, the compute 30 and the controller 10 are connected via a network.

The compute 30 includes a plurality of physical servers 31 (physical servers 31a to 31d) that implement a plurality of types of virtual machines/containers. In the description of the present embodiment, “/” means “or”. Each of the physical servers 31a to 31d constitutes a virtual server (compute), and implements resources such as a plurality of central processing units (CPUs), a memory, a system storage, and a network. In the present embodiment, in a case where it is not necessary to specify any one of the physical servers 31a to 31d, the physical server is simply referred to as the physical server 31.

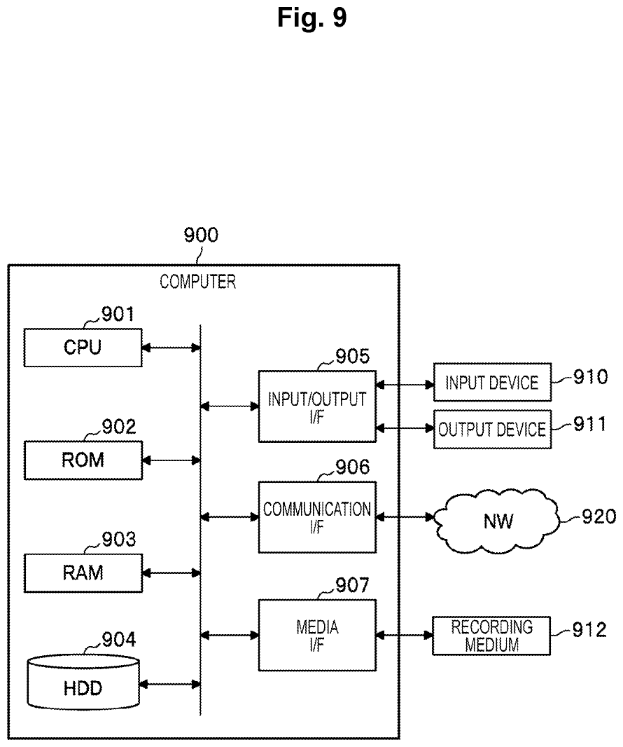

The controller 10 includes a monitoring unit 1, a monitoring frequency control unit 2, a database 3, an estimation unit 4, a control determination unit 5, a control unit 6, and a missing data processing unit 7. The controller 10 operates on the basis of a program stored in a ROM 902 or an HDD 904, which will be described later with reference to FIG. 9, and embodies the monitoring unit 1, the monitoring frequency control unit 2, the estimation unit 4, the control determination unit 5, the control unit 6, and the missing data processing unit 7.

The database 3 includes a data store 3a and a rule setting database 3b. The database 3 includes the ROM 902 or the HDD 904, which will be described later with reference to FIG. 9, and data collected from the physical servers 31a to 31d is stored in the data store 3a. In the rule setting database 3b, a monitoring rule indicating a frequency of data collection is set for each of the physical servers 31a to 31d.

In addition, data necessary for model construction is collected from the compute 30 (physical server group), and the data store 3a holds the collected data. Note that, in the present embodiment, the data stored in the data store 3a covers all the data that can be collected by a data collection unit 32, which will be described later, and corresponds to, for example, a CPU usage rate, an operating frequency of the CPU, a temperature of the physical server 31, a memory usage rate, the number of times of file reading and writing, and the like.

The monitoring unit 1 collects each piece of data of the compute 30 (a plurality of physical servers 31a to 31d: physical server group) and monitors a status of each of the physical servers 31a to 31d.

The monitoring frequency control unit 2 updates the collection mode of each piece of data on the basis of the monitoring rule corresponding to the physical server 31 set in the rule setting database 3b, and periodically sets the frequency of data collection executed according to the monitoring rule.

In addition, the monitoring frequency control unit 2 specifies a CPU core on which a data collection tool that collects data of the physical server 31 is executed. The monitoring frequency control unit 2 may lower the frequency of collection executed by the data collection tool on the basis of the usage rate of the specified CPU core. In this case, a predetermined threshold value can be set to, for example, 80% or more or a case where it exceeds 80%, and the monitoring frequency control unit 2 lowers the frequency of collection executed by the data collection tool in a case where the usage rate of the CPU core is 80% or more or exceeds 80%.

In addition, in a case where there is another CPU core whose usage rate of the CPU core is lower than a predetermined threshold value on the basis of the usage rate of the specified CPU core, the monitoring frequency control unit 2 may change the CPU core on which the data collection tool is executed to the other CPU core. In this case, for example, in a case where the physical server 31a is equipped with eight (Nos. 1 to 8) CPU cores, it is specified that the CPU core on which the data collection tool is executed is No. 5, and the usage rate of the No. 5 CPU core is 80% or more or exceeds 80%, the monitoring frequency control unit changes the CPU core to the No. 6 CPU core or No. 7 CPU core whose usage rate is lower than a predetermined threshold value.

In addition, the monitoring unit 1 may receive a feedback request from an application executed in the virtual machine/container. For example, in a case where there is a physical server 31 with reduced performance among the plurality of physical servers 31a to 31d to be monitored, the feedback request is a request to increase the frequency of data collection with respect to the physical server 31. That is, in the present embodiment, the monitoring frequency control unit 2 periodically sets the frequency of data collection for the physical server 31, but in a case where the application detects some kind of malfunction, the feedback request is a request to enhance monitoring of the physical server 31. In this case, the monitoring frequency control unit 2 shortens a collection interval of data with respect to the physical server 31 that executes the application and increases the frequency of collection, or sets the collection interval of data to a predetermined value and fixes the frequency of collection. Note that the feedback request is also included in the data collected from the compute 30 (physical server group).

The estimation unit 4 executes construction of a predetermined model. Specifically, the estimation unit 4 creates a model that estimates and calculates the power consumption of the physical server 31 from the performance data (for example, CPU usage rate or the like) of the physical server 31. Hereinafter, in the present embodiment, creating such a model will be referred to as model construction.

In this case, model construction is executed by the estimation unit 4 on the basis of the data held in the data store 3a, and the monitoring frequency control unit 2 shortens the collection interval of the data with respect to the physical server 31 that executes the application and increases the frequency of collection in a case where the number of pieces of data is insufficient or accuracy requirements for the data are not satisfied in the model construction.

The control determination unit 5 calculates a server power consumption for each physical server 31 from the model created by the estimation unit 4, and determines whether or not the calculated server power consumption exceeds a predetermined threshold value set in advance. In a case where the calculated server power consumption exceeds a predetermined threshold value, the control determination unit 5 controls processing for the physical server 31. That is, the control determination unit 5 executes processing of suppressing power consumption on the physical server 31 exceeding the predetermined threshold value.

For example, the control unit 6 changes the placement of components on the compute 30 (physical server group) and executes processing of reducing the number of physical servers 31 that are powered on. Specifically, the control unit 6 receives processing of suppressing power consumption from the control determination unit 5 and executes a change in the placement of the components.

In this case, with respect to the physical server 31 in which the power consumption exceeds a predetermined threshold value, the placed component is relocated to another physical server 31, and the load distribution of the power consumption is executed. Then, the control unit 6 appropriately turns off the power of the physical servers 31 that are powered on, and performs control so that the load of the power consumption of the operating physical servers 31 becomes uniform.

The missing data processing unit 7 executes processing of filling in missing data (this is also referred to as missing data processing). The missing data processing unit 7 executes missing data processing on the model created by the estimation unit 4 and reconstructs the model when the number of pieces of data for calculating the power consumption is insufficient or accuracy requirements for the data are not satisfied. Here, the missing data processing is not particularly limited, and can use, for example, a known technique such as a single imputation method (average value interpolation or median value interpolation), regression imputation method, or K-nearest neighbor method.

Note that, in the present embodiment, since the frequency of data collection can be varied, there is a likelihood that there is missing data in the data collected from the physical server 31. For example, due to a decrease in the frequency of data collection, a situation where data is insufficient (that is, missing data) is assumed even though data is periodically collected. In such a case, the missing data processing unit 7 fills in the missing data and reconstructs the model using a known technique such as the single imputation method, regression imputation method, or K-nearest neighbor method described above.

The controller 10 is configured by a physical server. A hardware configuration of the controller 10 will be described later with reference to FIG. 9. In addition, the plurality of physical servers 31 constituting the compute 30 also includes hardware similar to that of the controller 10 (not illustrated).

### <Configuration of Compute>

The compute 30 includes physical servers 31a to 31d (physical server 31). Each of the physical servers 31a to 31d (physical server 31) operates on the basis of a program stored in the ROM or the HDD, and embodies the data collection unit 32.

The data collection unit 32 executes a hardware performance analysis tool such as perf and dstat, for example, and executes real-time analysis of server resources for each physical server 31. In the present embodiment, a tool executed by the data collection unit 32 is referred to as a data collection tool.

The data collection unit 32 collects predetermined data of the physical server 31 according to the frequency of data collection set in the monitoring frequency control unit 2 of the controller 10. As an example, the physical server 31 is equipped with eight CPU cores, and a data collection tool is executed by any one of the eight CPU cores to collect predetermined data.

### <Monitoring Information of Rule Setting Database>

Next, the rule setting database 3b stored in the database 3 will be described. Note that, in the present embodiment, an application is abbreviated as an App, and is used as an “App lock”, “App modeling”, or the like.

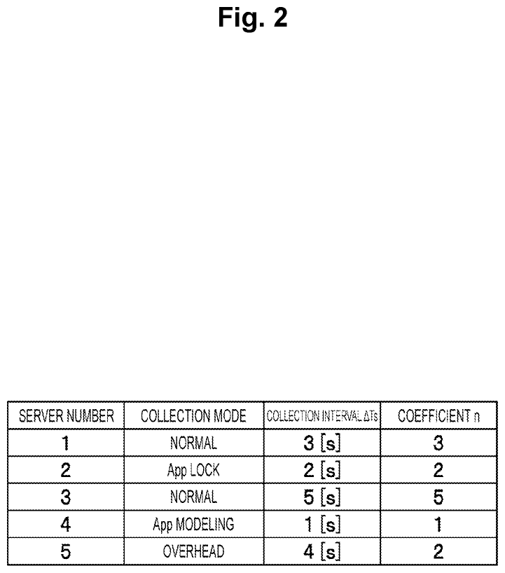

FIG. 2 is an explanatory diagram illustrating the rule setting database 3b stored in the database 3. As illustrated in FIG. 2, the rule setting database 3b includes items of a server number, a collection mode, a collection interval ΔTs, and a coefficient n. Note that the coefficient n is an integer.

In the physical server 31 with the server number 1, the collection mode is “normal” mode, the collection interval ΔTs is “3 [s]”, and the coefficient n is “3”. In the physical server 31 with the server number 2, the collection mode is “App lock” mode, the collection interval ΔTs is “2 [s]”, and the coefficient n is “2”. In the physical server 31 with the server number 3, the collection mode is “normal” mode, the collection interval ΔTs is “5 [s]”, and the coefficient n is “5”. In the physical server 31 with the server number 4, the collection mode is “App modeling” mode, the collection interval ΔTs is “1 [s]”, and the coefficient n is “1”. In the physical server 31 with the server number 5, the collection mode is “overhead”, the collection interval ΔTs is “4 [s]”, and the coefficient n is “2”.

As the collection mode, any one of four types of “normal”, “App lock”, “App modeling”, and “overhead” is allocated to each physical server 31. In the present embodiment, four types are allocated, but the present invention is not limited thereto, and a large number of collection modes can be set and allocated to each physical server 31. Each mode generally operates as follows.

“Normal” mode indicates a normal collection mode, and the collection interval is periodically increased.

In “App lock” mode, feedback is received from an App, and increasing a periodic collection interval is stopped. In addition, when the target App is deleted from the physical server 31, the mode is returned to the normal mode.

In “App modeling” mode, data is collected at a high frequency for model construction. When data collection necessary for modeling is ended, the mode is returned to the normal mode.

In “overhead” mode, when the usage rate of the CPU core at which the monitoring tool (data collection tool) operates is high, a collection interval of data is increased. Also, when the usage rate of the CPU core becomes low, the mode is returned to the normal mode.

Note that the collection interval ΔTs illustrated in FIG. 2 is a time interval at which data is collected, and n is a coefficient used to determine the time interval at which data is collected. Details of the collection mode will be described in a flowchart describing monitoring frequency management.

In the present embodiment, the monitoring frequency control unit 2 updates the collection mode of each piece of data on the basis of the monitoring rule corresponding to each physical server 31 set in the rule setting database 3b, and periodically sets the frequency of data collection executed according to the monitoring rule.

Accordingly, since the controller 10 can dynamically determine the optimal monitoring frequency using the monitoring frequency control unit 2, it is possible to suppress overhead and power consumption due to real-time monitoring.

### <Monitoring Frequency Management>

Next, processing of managing the monitoring frequency (monitoring frequency determination processing) in the controller 10 of the server monitoring system 100 according to the present embodiment will be described.

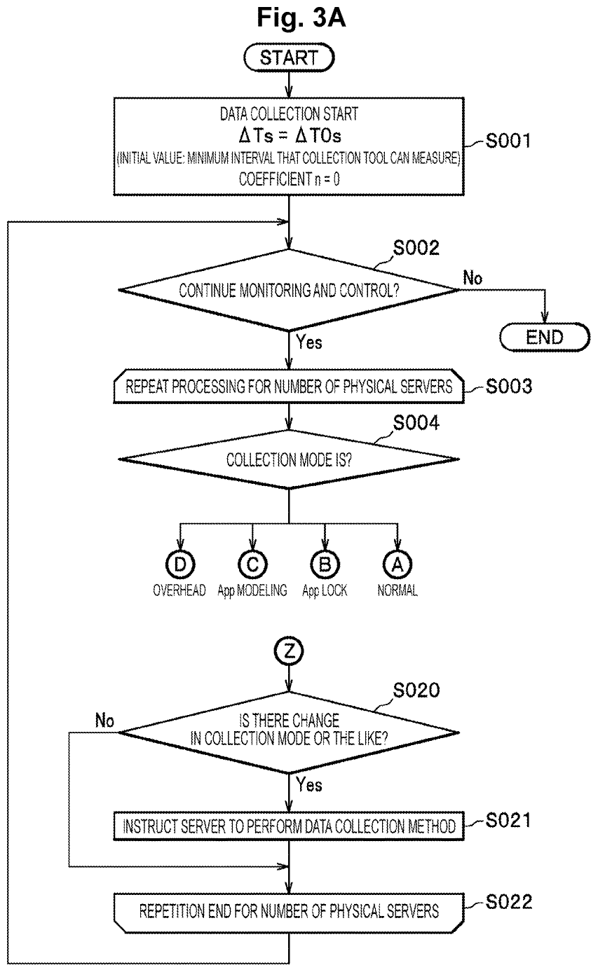

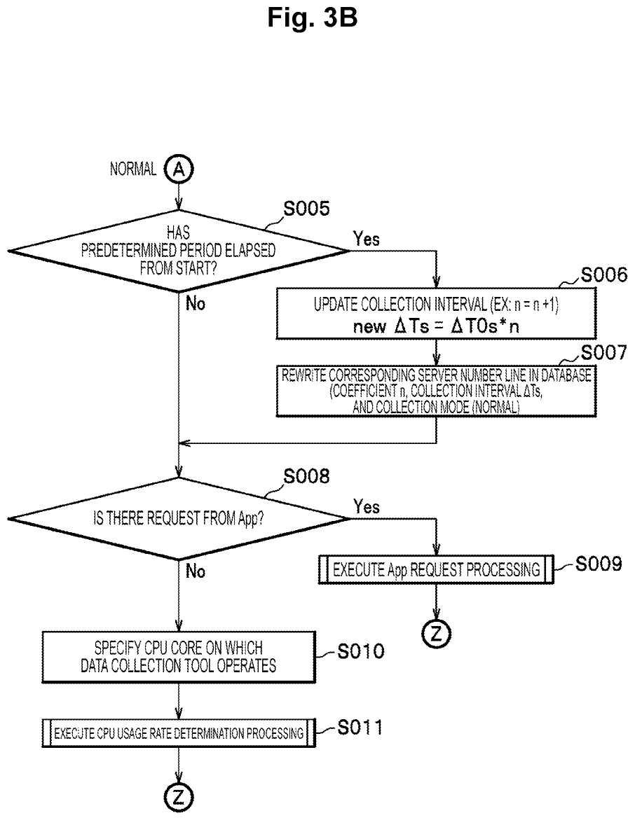

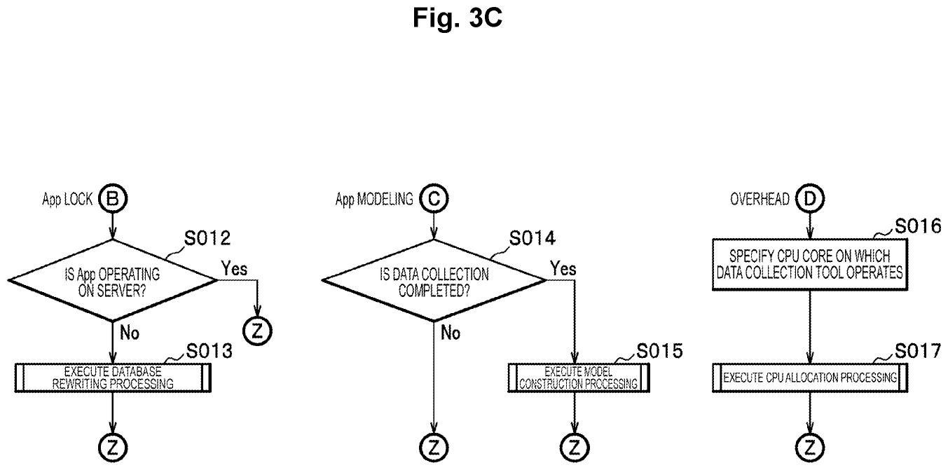

FIGS. 3A to 8 are flowcharts illustrating a flow of processing of collecting data from the compute 30 (physical server group) and determining a frequency at which the controller 10 monitors the compute 30 in the server monitoring system 100.

In the flowcharts illustrated in FIGS. 3A to 3C, the monitoring unit 1 and the monitoring frequency control unit 2 cooperate with each other to determine the frequency of monitoring the compute 30.

First, the monitoring unit 1 starts collecting each piece of data of the compute 30 (physical server group) and monitors the status of each of the physical servers 31a to 31d (step S001). At first, ΔT0s, which is the minimum interval that the data collection tool can collect, is set as the collection interval ΔTs of the data as an initial value.

The monitoring frequency control unit 2 receives an instruction of an operator (user), and determines whether or not to continue monitoring and control of the compute 30 according to the instruction of the operator (step S002). In a case where the monitoring and control of the compute 30 are not continued according to the instruction of the operator (No in step S002), the monitoring frequency control unit 2 ends the monitoring frequency determination processing.

On the other hand, in a case where monitoring and control of the compute 30 are continued according to the instruction of the operator (Yes in step S002), the monitoring frequency control unit 2 repeats processing of sequentially determining the monitoring frequency of the following monitoring for the number of physical servers 31 constituting the compute 30 (step S003).

Note that, in the present embodiment, the monitoring frequency control unit 2 is not limited to sequentially determining the monitoring frequency of monitoring for each physical server 31, and may determine the monitoring frequency of monitoring for each physical server 31 in parallel at the same time, for example.

For each physical server 31, the monitoring frequency control unit 2 determines the collection mode described in the rule setting database 3b in FIG. 2 (step S004), and executes processing corresponding to the following modes 1 to 4. Specifically, the monitoring frequency control unit 2 executes one of four types of modes: 1. Normal mode, 2. App lock mode, 3. App modeling mode, and 4. Overhead mode.
<1. Normal Mode>
<2. App Lock Mode>
<3. App Modeling Mode>
<4. Overhead Mode>

Note that, since these processes indicate the names of the modes, they may be simply referred to as normal, App lock, App modeling, and overhead.

### <1. Normal Mode>

In a case where the physical server 31 is in the normal mode (step S004), the monitoring frequency control unit 2 proceeds to step S005 in FIG. 3B and determines whether or not a predetermined period has elapsed from the start of data collection. In a case where the predetermined period has elapsed from the start of data collection (Yes in step S005), the monitoring frequency control unit 2 updates the collection interval (step S006).

In this case, for example, the monitoring frequency control unit 2 multiplies the initial value ΔT0s by the number obtained by adding 1 to the coefficient n as a collection interval ΔTs of new data (ΔTs=ΔT0s×(n+1)). The monitoring frequency control unit 2 updates the value obtained by the multiplication as the collection interval ΔTs of the data.

In the normal mode, the monitoring frequency control unit 2 can increase the collection interval ΔTs of the data by gradually increasing the coefficient n. Accordingly, the monitoring frequency control unit 2 can lower the frequency of data collection. Note that the collection interval of the data is updated every day, for example. In this manner, the monitoring frequency control unit 2 periodically (every day) sets (updates) the frequency of data collection by adding+1 to the daily coefficient n (n+1).

After updating the data collection interval ΔTs of the physical server 31, the monitoring frequency control unit 2 rewrites the data in the rule setting database 3b illustrated in FIG. 2 (step S007). Specifically, the monitoring frequency control unit 2 rewrites the coefficient n of the line of the corresponding physical server 31 and the collection interval ΔTs of the data in the rule setting database 3b in FIG. 2, and proceeds to step S08. Note that the collection mode remains in the normal mode, and thus is not changed even after rewriting.

On the other hand, in a case where the predetermined period has not elapsed from the start of data collection (No in step S005), or after the contents of the rule setting database 3b in FIG. 2 are rewritten (step S007), the monitoring frequency control unit 2 determines whether or not there is a request from an App (step S008).

In a case where there is a request from an App (Yes in step S008), the monitoring frequency control unit 2 proceeds to step S009, executes App request processing (step S009), and proceeds to step S020 in FIG. 3A.

On the other hand, in a case where there is no request from the App (No in step S008), the monitoring frequency control unit 2 proceeds to step S010, specifies the CPU core on which the data collection tool operates, and proceeds to step S011. In step S011, the monitoring frequency control unit 2 executes CPU usage rate determination processing, and proceeds to step S020 in FIG. 3A.

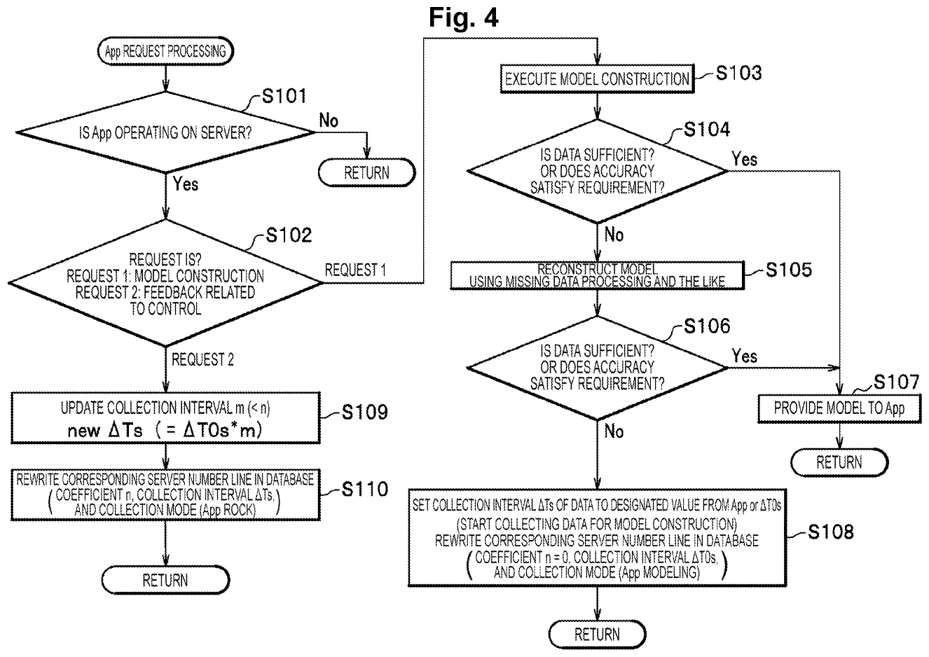

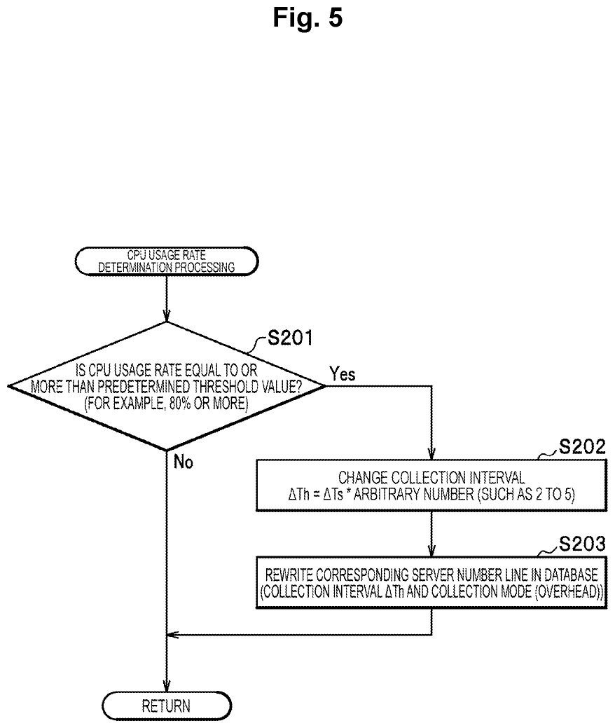

Note that the App request processing in step S009 will be described with reference to FIG. 4, and the CPU usage rate determination processing in step S011 will be described with reference to FIG. 5.

### <2. App Lock Mode>

Referring back to FIG. 3A, in the case of the App lock mode (step S004), the monitoring frequency control unit 2 proceeds to step S012 in FIG. 3A and determines whether or not the App is operating on the server. In step S012, in a case where the App is operating on the physical server 31 (Yes in step S012), the monitoring frequency control unit 2 proceeds to step S020 in FIG. 3A.

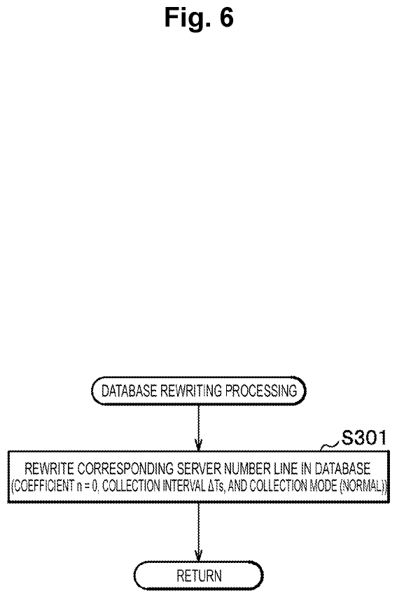

On the other hand, in a case where the App is not in operation on the physical server 31 (No in step S012), the monitoring frequency control unit 2 executes database rewriting processing (step S013), and proceeds to step S020 in FIG. 3A. The database rewriting processing will be described with reference to FIG. 6.

In the App lock mode, the collection interval ΔTs of the data is updated by executing the database rewriting processing in FIG. 6. That is, the monitoring frequency control unit 2 receives feedback related to control from the App, is changed to the App lock mode, and updates the collection interval ΔTs of the data. Specifically, in a case where there is performance degradation in the physical server 31, the monitoring frequency control unit 2 narrows the collection interval ΔTs of the data to increase the frequency of data collection.

In this case, the monitoring frequency control unit 2 sets the collection interval ΔTs of the data to, for example, an initial value ΔT0s×a coefficient m. m is a predetermined integer smaller than the coefficient n at the time of receiving the feedback from the App.

On the other hand, in the normal mode, for example, by increasing the collection interval ΔTs of the data, the monitoring frequency control unit 2 delays the control such as scale-in/scale-out of the physical server 31, and the influence may appear in the quality of service. In a case where the quality of the service is affected, the monitoring frequency control unit 2 receives feedback such as a request for monitoring enhancement from a service provider (App administrator). In such a case, the monitoring frequency control unit 2 does not increase the frequency of collection and fixes the collection interval ΔTs of the data.

### <3. App Modeling Mode>

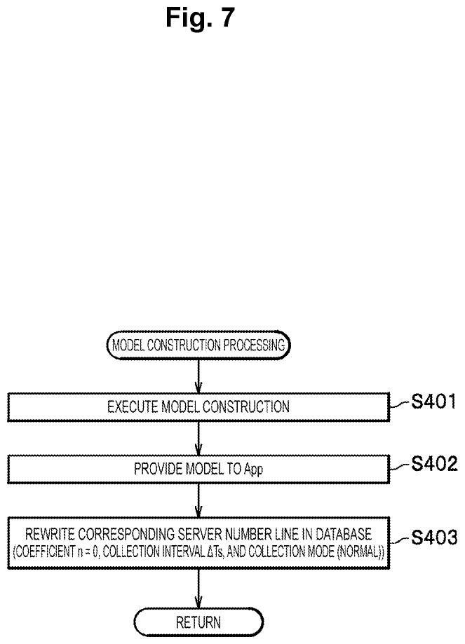

Referring back to FIG. 3A, in the case of the App modeling mode (step S004), the monitoring frequency control unit 2 proceeds to step S014 in FIG. 3C and determines whether or not data collection is completed. In a case where the data collection is completed (Yes in step S014), the estimation unit 4 executes model construction processing (step S015), and proceeds to step S020 in FIG. 3A. The model construction processing will be described with reference to FIG. 7.

On the other hand, in a case where the data collection is not completed (No in step S014), the monitoring frequency control unit 2 proceeds to step S020 in FIG. 3A.

In the App modeling mode, by executing the model construction processing in FIG. 7, model construction is executed with the data held in the data store 3a of the database 3. The estimation unit 4 executes model construction, and in a case where the number of pieces of data is insufficient or accuracy requirements for the data are not satisfied, the estimation unit 4 sets a modeling mode in which the collection interval ΔTs of the data is set to be narrow.

After the estimation unit 4 finishes collecting data for constructing a model, the estimation unit 4 returns to the original collection interval ΔTs of the data. In this case, the collection interval ΔTs of the data is set to a designated value from the App or an initial value ΔT0s. Note that the estimation unit 4 may reduce power consumption by increasing or decreasing the number of pieces of data collection items.

### <4. Overhead Mode>

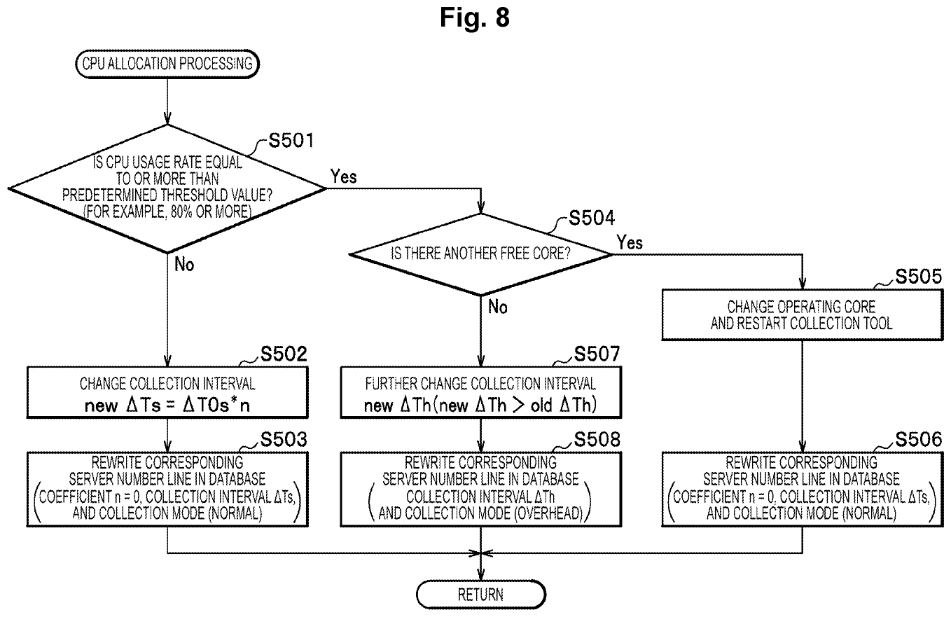

Referring back to FIG. 3A, in the case of the overhead mode (step S004), the monitoring frequency control unit 2 proceeds to step S016 in FIG. 3C, specifies the CPU core on which the data collection tool operates, and proceeds to step S017. After executing the CPU allocation processing (step S017), the monitoring frequency control unit 2 proceeds to step S020 in FIG. 3A. The CPU allocation processing will be described with reference to FIG. 8.

In the overhead mode, in a case where the CPU usage rate continues to be high in the physical server 31 and there are other free CPUs, the monitoring frequency control unit 2 changes the operating core to the free CPU. In a case where there is no free CPU, the monitoring frequency control unit 2 further changes the collection interval ΔTs of the data to, for example, a collection interval ΔTh obtained by multiplying the collection interval ΔTs of the data by an arbitrary constant (2 to 5). In this manner, the monitoring frequency control unit 2 sets the collection interval ΔTh of the data to be larger than the current collection interval ΔTs of the data.

Next, in step S020, the monitoring frequency control unit 2 determines whether or not there is a change in the data collection mode or the like. In a case where there is a change in the data collection mode or the like (Yes in step S020), the monitoring frequency control unit 2 notifies the physical server 31 of the data collection method and instructs it to collect data in the changed collection mode (step S021).

On the other hand, in a case where there is no change in the data collection mode (No in step S020) or after the instruction of the collection mode (step S021), the monitoring frequency control unit 2 determines whether monitoring and control of all the physical servers 31 have ended (step S022).

In a case where there is a physical server 31 whose monitoring and control have not been ended, the monitoring frequency control unit 2 returns to step S002 and repeats the processing until the monitoring and control of all the physical servers 31 are ended (steps S003 to S022).

In this manner, the monitoring frequency control unit 2 sequentially determines the monitoring frequency for all the physical servers 31, and executes the monitoring frequency determination processing for the number of physical servers 31. In addition, in a case where the monitoring frequency determination processing is executed for each of the physical servers 31 in parallel, the monitoring frequency control unit 2 executes the monitoring frequency determination processing for all the physical servers 31 in a processing time corresponding to one physical server 31.

### <Description of Each Processing>

Next, each processing of App request processing, CPU usage rate determination processing, database rewriting processing, model construction processing, and CPU allocation processing will be described.

### <App Request Processing>

FIG. 4 is a flowchart illustrating a flow of App request processing in step S009 in FIG. 3B.

As illustrated in FIG. 4, the monitoring frequency control unit 2 determines whether or not an App is operating on the physical server 31 (step S101). In a case where the App is not operating on the physical server 31 (No in step S101), the process proceeds to step S020 in FIG. 3A.

On the other hand, in a case where the App is operating on the physical server 31 (Yes in step S101), the monitoring frequency control unit 2 proceeds to step S102 and determines whether the request from the App is model construction (request 1) or feedback related to control (request 2).

In a case where the request from the App is model construction (request 1 in step S102), the monitoring frequency control unit 2 proceeds to step S103, and the estimation unit 4 executes model construction.

On the other hand, in a case where the request from the App is feedback related to control (request 2 in step S102), the monitoring frequency control unit 2 updates the collection interval ΔTs of the data (step S109).

In this case, for example, the monitoring frequency control unit 2 assigns m to the coefficient n as the collection interval ΔTs of new data, and multiplies the initial value ΔT0s by the coefficient m (ΔTs=ΔT0s×m). Note that the coefficient m is an integer smaller than the coefficient n. Accordingly, the monitoring frequency control unit 2 updates the value obtained by the multiplication as the collection interval ΔTs of the data (step S109).

The monitoring frequency control unit 2 can narrow the collection interval ΔTs of the data by assigning an integer smaller than the coefficient n to the coefficient m (m<n), thereby increasing the frequency of data collection.

After updating the collection interval ΔTs of the physical server 31, the monitoring frequency control unit 2 rewrites the data in the rule setting database 3b illustrated in FIG. 2 (step S110). Specifically, the monitoring frequency control unit 2 rewrites the coefficient n, the collection interval ΔTs, and the collection mode (App lock) of the line of the corresponding physical server 31 in the rule setting database 3b in FIG. 2, and proceeds to step S020 in FIG. 3A.

On the other hand, in a case where the request from the App is model construction (request 1 in step S102), the estimation unit 4 executes model construction (step S103). Then, the estimation unit 4 determines whether or not the number of pieces of data of the constructed model is sufficient or the accuracy satisfies a requirement (step S104).

In a case where the number of pieces of data of the constructed model is not sufficient or the accuracy does not satisfy the requirement (No in step S104), the estimation unit 4 cooperates with the missing data processing unit 7 to perform missing data processing and reconstruct the model (step S105). Then, the estimation unit 4 redetermines whether or not the number of pieces of data of the reconstructed model is sufficient or the accuracy satisfies a requirement (step S106).

On the other hand, in a case where the number of pieces of data of the constructed model is sufficient and the accuracy satisfies the requirement (Yes in step S104), the monitoring frequency control unit 2 proceeds to step S107.

In step S106, in a case where the number of pieces of data of the reconstructed model is not sufficient or the accuracy does not satisfy the requirement (No in step S106), for example, the monitoring frequency control unit 2 sets the collection interval ΔTs of the data to a designated value from the App or the initial value ΔT0s as a collection interval ΔTs of new data (step S108).

In this case, the monitoring frequency control unit 2 causes the data collection tool of the data collection unit 32 to start collecting data for model construction. Then, the monitoring frequency control unit 2 rewrites the data in the rule setting database 3b illustrated in FIG. 2.

Specifically, the monitoring frequency control unit 2 changes the coefficient n of the line of the corresponding physical server 31 to 0 in the rule setting database 3b in FIG. 2, rewrites the coefficient n to the initial value ΔT0s and the collection mode (App modeling), and proceeds to step S020 in FIG. 3A.

On the other hand, in a case where the number of pieces of data of the reconstructed model is sufficient and the accuracy satisfies the requirement (Yes in step S106), the monitoring frequency control unit 2 proceeds to step S107.

In step S107, the monitoring frequency control unit 2 provides the constructed model to the App in which there is a request from the compute 30 (physical server group), and the process proceeds to step S020 in FIG. 3A.

### <CPU Usage Rate Determination Processing>

FIG. 5 is a flowchart illustrating a flow of CPU usage rate determination processing in step S011 in FIG. 3B.

As illustrated in FIG. 5, the monitoring frequency control unit 2 executes CPU usage rate determination processing. In this case, the monitoring frequency control unit 2 specifies the CPU core on which the data collection tool of the data collection unit 32 operates, and determines whether or not the CPU usage rate is equal to or more than a predetermined threshold value (step S201). The predetermined threshold value is, for example, 80%. In a case where the CPU usage rate of the specified CPU core is 80% or more (Yes in step S201), the monitoring frequency control unit 2 changes the collection interval ΔTh of the data to be widened (step S202).

In this case, for example, the monitoring frequency control unit 2 changes the collection interval ΔTs of the data to a collection interval ΔTh obtained by multiplying the collection interval ΔTs of the data by an arbitrary number (such as 2 to 5), and proceeds to step S203.

On the other hand, in a case where the CPU usage rate of the specified CPU core is less than 80% (No in step S201), the monitoring frequency control unit 2 determines that there is still room for the CPU core, does not perform any processing, and proceeds to step S020 in FIG. 3A.

In step S203, the monitoring frequency control unit 2 rewrites the collection interval ΔTh and the collection mode (overhead) of the line of the corresponding physical server 31 in the rule setting database 3b, and proceeds to step S020 in FIG. 3A.

### <Database Rewriting Processing>

FIG. 6 is a flowchart illustrating a flow of database rewriting processing in step S013 in FIG. 3C. In this case, the monitoring frequency control unit 2 illustrates a case where an App is not operating on the physical server 31 in the App lock mode.

As illustrated in FIG. 6, the monitoring frequency control unit 2 rewrites the rule setting database 3b illustrated in FIG. 2 to the contents of the normal mode (step S301). Specifically, the monitoring frequency control unit 2 changes the coefficient n of the line of the corresponding physical server 31 to 0 in the rule setting database 3b in FIG. 2, rewrites the coefficient n to the collection interval ΔTs of the data and the collection mode (normal), and proceeds to step S020 in FIG. 3A.

### <Model Construction Processing>

FIG. 7 is a flowchart illustrating a flow of model construction processing in step S15 in FIG. 3C.

As illustrated in FIG. 7, the estimation unit 4 cooperates with the missing data processing unit 7 to execute model construction processing (step S401). The estimation unit 4 provides the constructed model to the App of the compute 30 (physical server group) via the control determination unit 5 and the control unit 6 (step S402).

In this case, upon providing the constructed model, the monitoring frequency control unit 2 rewrites the data in the rule setting database 3b illustrated in FIG. 2 (step S403). Specifically, the monitoring frequency control unit 2 changes the coefficient n of the line of the corresponding physical server 31 to 0 in the rule setting database 3b, rewrites the coefficient n to the collection interval ΔTs of the data and the collection mode (normal), and proceeds to step S020 in FIG. 3A.

### <CPU Allocation Processing>

FIG. 8 is a flowchart illustrating a flow of CPU allocation processing in step S17 in FIG. 3C.

As illustrated in FIG. 8, the monitoring frequency control unit 2 determines the CPU usage rate. In this case, the monitoring frequency control unit 2 determines whether or not the CPU usage rate is equal to or more than a predetermined threshold value (step S501). For example, in a case where the predetermined threshold value is set to 80% and the CPU usage rate of the specified CPU core is 80% or more (Yes in step S501), the monitoring frequency control unit 2 proceeds to step S504.

On the other hand, in a case where the CPU usage rate of the specified CPU core is less than 80% (lower than the predetermined threshold value) (No in step S501), the monitoring frequency control unit 2 changes the collection interval ΔTs of the data to a value obtained by multiplying the initial value ΔT0s by the coefficient n (step S502). However, in the setting of the collection interval ΔTs, 1 is assigned to the coefficient n (n=1) and multiplied by the initial value ΔT0s. The monitoring frequency control unit 2 sets the initial value ΔT0s as the collection interval ΔTs and starts the coefficient n from 0 to return to the normal mode, and proceeds to step S503.

In step S503, the monitoring frequency control unit 2 rewrites the data in the rule setting database 3b illustrated in FIG. 2. Specifically, the monitoring frequency control unit 2 changes the coefficient n of the line of the corresponding physical server 31 to 0 in the rule setting database 3b in FIG. 2, rewrites the coefficient n to the collection interval ΔTs of the data and the collection mode (normal), and proceeds to step S020 in FIG. 3A.

In step S504, in a case where there is another free core (Yes in step S504), the monitoring frequency control unit 2 changes the operating core and restarts the data collection by the data collection tool of the data collection unit 32 (step S505). Then, the monitoring frequency control unit 2 proceeds to step S506.

On the other hand, in a case where there is no other free core (No in step S504), the monitoring frequency control unit 2 changes the collection interval ΔTh to be further widened (step S507). In this case, for example, the monitoring frequency control unit 2 sets the collection interval ΔTh obtained by multiplying the collection interval ΔTh by an arbitrary constant (2 to 5) as the collection interval ΔTh of new data. Note that how to widen the collection interval of data is not particularly limited. Then, the monitoring frequency control unit 2 proceeds to step S508.

In step S506, the monitoring frequency control unit 2 rewrites the data in the rule setting database 3b illustrated in FIG. 2. Specifically, the monitoring frequency control unit 2 changes the coefficient n of the line of the corresponding physical server 31 to 0 in the rule setting database 3b in FIG. 2, rewrites the coefficient n to the collection interval ΔTs of the data and the collection mode (normal), and proceeds to step S020 in FIG. 3A.

Furthermore, in step S508, the monitoring frequency control unit 2 rewrites the data in the rule setting database 3b illustrated in FIG. 2. Specifically, the monitoring frequency control unit 2 rewrites the collection interval ΔTh and the collection mode (overhead) of the data line of the corresponding physical server 31 in the rule setting database 3b in FIG. 2, and proceeds to step S020 in FIG. 3A.

As described above, the controller 10 of the server monitoring system 100 according to the present embodiment includes the monitoring unit 1, the rule setting database 3b, and the monitoring frequency control unit 2. The monitoring unit 1 collects each piece of data of the compute 30 (physical server group) and monitors a status of each physical server 31. The monitoring frequency control unit 2 updates the collection mode of each piece of data on the basis of the monitoring rule corresponding to the physical server 31 set in the rule setting database 3b, and periodically sets the frequency of data collection executed according to the monitoring rule.

Accordingly, the controller 10 can suppress overhead and power consumption due to real-time monitoring on a service infrastructure in which a wide variety of applications are installed on hardware and a combination of the applications is dynamically changed.

### <Hardware Configuration of Controller>

The controller 10 according to the present embodiment is implemented by a computer 900 as illustrated in FIG. 9, for example.

FIG. 9 is a hardware configuration diagram illustrating an example of the computer 900 that implements functions of the controller 10 according to the present embodiment.

The computer 900 includes a central processing unit (CPU) 901, a read only memory (ROM) 902, a random access memory (RAM) 903, a hard disk drive (HDD) 904, an input/output interface (I/F) 905, a communication I/F 906, and a media I/F 907.

The CPU 901 operates on the basis of a program stored in the ROM 902 or the HDD 904, and functions as each functional unit (monitoring unit 1, monitoring frequency control unit 2, and the like) of the controller 10 illustrated in FIG. 1.

The ROM 902 stores a boot program to be executed by the CPU 901 when the computer 900 is started, a program related to hardware of the computer 900, and the like.

The CPU 901 controls, via the input/output I/F 905, an input device 910 such as a mouse or a keyboard, and an output device 911 such as a display. Via the input/output I/F 905, the CPU 901 acquires data from the input device 910, and outputs generated data to the output device 911. Note that a GPU or the like may be used as a processor together with the CPU 901.

The HDD 904 stores a program to be executed by the CPU 901, data to be used by the program, and the like. The communication I/F 906 receives data from another device (for example, compute 30) via a communication network (for example, a network (NW) 920), outputs the data to the CPU 901, and transmits data generated by the CPU 901 to another device (for example, compute 30) via the communication network.

The media I/F 907 reads a program or data stored in a recording medium 912, and outputs the program or data to the CPU 901 via the RAM 903. The CPU 901 loads a program related to target processing from the recording medium 912 into the RAM 903 via the media I/F 907, and executes the loaded program. The recording medium 912 is an optical recording medium such as a digital versatile disc (DVD) or a phase change rewritable disk (PD), a magneto-optical recording medium such as a magneto-optical disk (MO), a magnetic recording medium, a conductor memory tape medium, a semiconductor memory, or the like.

For example, in a case where the computer 900 functions as the controller 10 according to the first embodiment, the CPU 901 of the computer 900 implements each functional unit (monitoring unit 1, monitoring frequency control unit 2, and the like) of the controller 10 by executing a program loaded on the RAM 903.

The HDD 904 stores data in the RAM 903. The CPU 901 reads a program related to target processing from the recording medium 912, and executes the program.

Additionally, the CPU 901 may read a program related to target processing from another device via the communication network (NW 920).

### <Effects>

Hereinafter, effects of the controller 10 according to the present embodiment will be described.
(1) The controller 10 includes: a monitoring unit 1 that collects each piece of data of a physical server group including a plurality of physical servers that implement a compute on which a virtual machine/container is mounted and monitors a status of each of physical servers 31; a rule setting database 3b in which a monitoring rule indicating a frequency of data collection is set for each of the physical servers 31; and a monitoring frequency control unit 2 that updates a collection mode of each piece of the data on the basis of the monitoring rule corresponding to the physical server 31 set in the rule setting database 3b, and periodically sets the frequency of data collection executed according to the monitoring rule.

The monitoring unit 1 collects each piece of data of the compute 30 (physical server group) and monitors a status of each physical server 31. The monitoring frequency control unit 2 updates the collection mode of each piece of data on the basis of the monitoring rule corresponding to the physical server 31, and periodically sets the frequency of data collection executed according to the monitoring rule. Accordingly, the controller 10 can dynamically determine the monitoring frequency of collection for each of the physical servers 31 and periodically update the monitoring frequency of collection.

Therefore, when periodically updating the monitoring frequency of collection, the controller 10 can increase the collection interval of data of the compute 30 (physical server group), and can gradually reduce power consumption related to monitoring.

Therefore, the controller 10 can suppress overhead and power consumption due to real-time monitoring on a service infrastructure in which a wide variety of applications are installed on hardware and a combination of the applications is dynamically changed.
(2) The monitoring unit 1 of the controller 10 described in (1) receives a feedback request from an application executed on the virtual machine/container, and the monitoring frequency control unit 2 shortens a collection interval of data with respect to the physical server 31 that executes the application and increases the frequency of collection, or sets the collection interval of data to a predetermined value and fixes the frequency of collection.

The monitoring unit 1 receives a feedback request from the application, and the monitoring frequency control unit 2 stops increasing the collection interval of periodic data by receiving the feedback in the monitoring unit 1. That is, the monitoring frequency control unit 2 dynamically determines an optimal frequency of monitoring by shortening the collection interval of data and increasing the frequency of collection or setting the collection interval of data to a predetermined value and fixing the frequency of collection.

Accordingly, the controller 10 can dynamically determine the optimal frequency of monitoring, and can solve the problem due to the increase in the collection interval of data.
(3) The monitoring frequency control unit 2 of the controller 10 described in (1) or (2) specifies a CPU core on which a data collection tool that collects data of the physical server 31 is executed, and lowers the frequency of collection executed by the data collection tool on the basis of a usage rate of the specified CPU core.

Since the data collection tool is executed by the physical server 31, there is a likelihood that processing of the data collection tool and processing of the application will conflict with each other in the OS of the physical server 31. Since the execution of the data collection tool increases a probability that the processing of the data collection tool and the processing of the application will conflict with each other, it is necessary to avoid an unstable operation for an application (for example, a communication system or the like) requiring stable processing performance.

Therefore, by managing the usage rate of the CPU core with a predetermined threshold value, the monitoring frequency control unit 2 can lower the frequency of collection executed by the data collection tool, and can avoid an unstable operation in advance. For example, in a case where the predetermined threshold value of the CPU core is set to 80% and the usage rate of the CPU core is 80% or more, the monitoring frequency control unit 2 lowers the frequency of collection executed by the data collection tool. Accordingly, the monitoring frequency control unit 2 can prevent any influence on other applications processed by the same CPU core in advance.
(4) The monitoring frequency control unit 2 of the controller 10 described in (1) or (2) specifies a CPU core on which a data collection tool that collects data of the physical server 31 is executed, and changes the CPU core on which the data collection tool is executed to another CPU core on the basis of a usage rate of the specified CPU core in a case where there is this other CPU core in which the usage rate of the CPU core is lower than a predetermined threshold value.

The monitoring frequency control unit 2 can achieve load distribution of the CPU core by managing the usage rate of the CPU core with a predetermined threshold value and changing the CPU core on which the data collection tool is executed to another CPU core. In addition, the monitoring frequency control unit 2 can suppress power consumption of the physical server 31. Accordingly, since the monitoring frequency control unit 2 can avoid a high load of the CPU core, it is possible to maintain a stable operation of the physical server 31.
(5) The controller 10 described in (1) further includes: an estimation unit 4 that executes construction of a predetermined model; and a data store 3a in which data necessary for constructing the model is collected and the collected data is held, the monitoring unit 1 receives a request to construct a model from an application executed on the virtual machine/container, and construction of the model is executed by the estimation unit 4 on the basis of the data held in the data store 3a, and the monitoring frequency control unit 2 shortens a collection interval of data with respect to the physical server 31 that executes the application and increases the frequency of collection in a case where the number of pieces of data is insufficient or accuracy requirements for the data are not satisfied in the construction of the model.

In this manner, the estimation unit 4 executes model construction according to an instruction from the monitoring frequency control unit 2. In a case where the accuracy of the constructed model is insufficient, the monitoring frequency control unit 2 can compensate for the shortage of the number of pieces of data or the accuracy of the data in constructing the model by the estimation unit 4 by shortening the collection interval of data and increasing the frequency of collection.
(6) The server monitoring system 100 includes: a monitoring unit 1 that collects each piece of data of a physical server group including a plurality of physical servers 31 that implement a compute on which a virtual machine/container is mounted and monitors a status of each of the physical servers 31; a rule setting database 3b in which a monitoring rule indicating a frequency of data collection is set for each of the physical servers 31; a monitoring frequency control unit 2 that updates a collection mode of each piece of the data on the basis of the monitoring rule corresponding to the physical server 31 set in the rule setting database 3b, and periodically sets the frequency of data collection executed according to the monitoring rule; and a data collection unit 32 that collects predetermined data of the physical server 31 according to the frequency of collection of the data set in the monitoring frequency control unit 2.

The server monitoring system 100 further includes a compute 30 (physical server group) in addition to the controller 10. In addition, the physical server 31 includes a data collection unit 32, and the data collection unit 32 is executed as a data collection tool. Thereby, in the server monitoring system 100, the monitoring unit 1 can collect data from each physical server 31 by the data collection unit 32. In addition, the server monitoring system 100 can dynamically determine the monitoring frequency of collection for each physical server 31 by the controller 10 and periodically update the monitoring frequency of collection.

Therefore, when periodically updating the monitoring frequency of collection, the server monitoring system 100 can increase the collection interval of data of the compute 30 (physical server group), and can gradually reduce power consumption related to monitoring.

Therefore, the server monitoring system 100 can suppress overhead and power consumption due to real-time monitoring on a service infrastructure in which a wide variety of applications are installed on hardware and a combination of the applications is dynamically changed.
(7) The server monitoring method is executed by a server monitoring device, and the server monitoring method includes: a step of collecting each piece of data of a physical server group including a plurality of physical servers that implement a compute on which a virtual machine/container is mounted and monitoring a status of each of the physical servers 31; and a step of updating a collection mode of each piece of the data on the basis of a monitoring rule indicating a frequency of data collection for each of the physical servers 31, and periodically setting the frequency of data collection executed according to the monitoring rule.

In the server monitoring method, the server monitoring device collects data of the compute 30 (physical server group). Furthermore, in the server monitoring method, the server monitoring device dynamically determines the monitoring frequency of collection for each of the physical servers 31 on the basis of the monitoring rule and periodically updates the monitoring frequency of collection.

Therefore, when periodically updating the monitoring frequency of collection, the server monitoring method can increase the collection interval of data of the compute 30 (physical server group), and can gradually reduce power consumption related to monitoring.

Therefore, the server monitoring method can suppress overhead and power consumption due to real-time monitoring on a service infrastructure in which a wide variety of applications are installed on hardware and a combination of the applications is dynamically changed.
(8) The program causes a computer to execute: a procedure of collecting each piece of data of a physical server group including the plurality of physical servers 31 that implement a compute on which a virtual machine/container is mounted and monitoring a status of each of the physical servers 31; and a procedure of updating a collection mode of each piece of the data on the basis of a monitoring rule indicating a frequency of data collection for each of the physical servers 31, and periodically setting the frequency of data collection executed according to the monitoring rule.

In the program, the computer collects data of the compute 30 (physical server group). Furthermore, in this program, the computer dynamically determines the monitoring frequency of collection for each of the physical servers 31 on the basis of the monitoring rule and periodically updates the monitoring frequency of collection.

Therefore, when periodically updating the monitoring frequency of collection, this program can increase the collection interval of data of the compute 30 (physical server group), and can gradually reduce power consumption related to monitoring.

Therefore, this program can suppress overhead and power consumption due to real-time monitoring on a service infrastructure in which a wide variety of applications are installed on hardware and a combination of the applications is dynamically changed.

Note that the present invention is not limited to the present embodiment described above, and many modifications can be made by those skilled in the art within the technical idea of the present invention.

Reference Signs List

| | |
|---|---|
| 1 | Monitoring unit |
| 2 | Monitoring frequency control unit |
| 3 | Database |
| 3a | Data store |
| 3b | Rule setting database |
| 4 | Estimation unit |
| 5 | Control determination unit |
| 6 | Control unit |
| 7 | Missing data processing unit |
| 10 | Controller (server monitoring device) |
| 30 | Compute (physical server group) |
| 31 | Physical server |
| 32 | Data collection unit |
| 100 | Server monitoring system |

1. A server monitoring device comprising:
a monitoring unit, including one or more processors, configured to collect each piece of data of a physical server group including a plurality of physical servers that implement a compute on which a virtual machine/container is mounted and monitors a status of each of the physical servers;
a rule setting database in which a monitoring rule indicating a frequency of data collection is set for each of the physical servers; and
a monitoring frequency control unit, including one or more processors, configured to update a collection mode of each piece of the data on the basis of the monitoring rule corresponding to the physical server set in the rule setting database, and periodically set the frequency of data collection executed according to the monitoring rule.

2. The server monitoring device according to claim 1, wherein
the monitoring unit is configured to receive a feedback request from an application executed on the virtual machine/container, and
the monitoring frequency control unit is configured to shorten a collection interval of data with respect to the physical server that executes the application and increase the frequency of collection, or sets the collection interval of data to a predetermined value and fixes the frequency of collection.

3. The server monitoring device according to claim 1, wherein the monitoring frequency control unit is configured to specify a CPU core on which a data collection tool that collects data of the physical server is executed, and lower the frequency of collection executed by the data collection tool on the basis of a usage rate of the specified CPU core.

4. The server monitoring device according to claim 1, wherein the monitoring frequency control unit is configured to specify a CPU core on which a data collection tool that collects data of the physical server is executed, and change the CPU core on which the data collection tool is executed to another CPU core on the basis of a usage rate of the specified CPU core in a case where there is this other CPU core in which the usage rate of the CPU core is lower than a predetermined threshold value.

5. The server monitoring device according to claim 1, further comprising:
an estimation unit, including one or more processors, configured to execute construction of a predetermined model; and
a data store in which data necessary for constructing the model is collected and the collected data is held, wherein
the monitoring unit is configured to receive a request to construct a model from an application executed on the virtual machine/container, and
construction of the model is executed by the estimation unit on the basis of the data held in the data store, and the monitoring frequency control unit shortens a collection interval of data with respect to the physical server that executes the application and increases the frequency of collection in a case where the number of pieces of data is insufficient or accuracy requirements for the data are not satisfied in the construction of the model.

6. A server monitoring system comprising:
a monitoring unit, including one or more processors, configured to collect each piece of data of a physical server group including a plurality of physical servers that implement a compute on which a virtual machine/container is mounted and monitors a status of each of the physical servers;
a rule setting database in which a monitoring rule indicating a frequency of data collection is set for each of the physical servers;
a monitoring frequency control unit, including one or more processors, configured to update a collection mode of each piece of the data on the basis of the monitoring rule corresponding to the physical server set in the rule setting database, and periodically set the frequency of data collection executed according to the monitoring rule; and
a data collection unit, including one or more processors, configured to collect predetermined data of the physical server according to the frequency of collection of the data set in the monitoring frequency control unit.

7. A server monitoring method executed by a server monitoring device, the method comprising:
collecting each piece of data of a physical server group including a plurality of physical servers that implement a compute on which a virtual machine/container is mounted and monitoring a status of each of the physical servers; and
updating a collection mode of each piece of the data on the basis of a monitoring rule indicating a frequency of data collection for each of the physical servers, and periodically setting the frequency of data collection executed according to the monitoring rule.

8. A non-transitory computer-readable storage medium storing a program for causing a computer to perform the server monitoring method of according to claim 7.

9. The server monitoring method according to claim 7, further comprising:
receiving a feedback request from an application executed on the virtual machine/container; and
shortening a collection interval of data with respect to the physical server that executes the application and increases the frequency of collection, or setting the collection interval of data to a predetermined value and fixes the frequency of collection.

10. The server monitoring method according to claim 7, further comprising:
specifying a CPU core on which a data collection tool that collects data of the physical server is executed, and lowering the frequency of collection executed by the data collection tool on the basis of a usage rate of the specified CPU core.

11. The server monitoring method according to claim 7, further comprising:
specifying a CPU core on which a data collection tool that collects data of the physical server is executed, and changing the CPU core on which the data collection tool is executed to another CPU core on the basis of a usage rate of the specified CPU core in a case where there is this other CPU core in which the usage rate of the CPU core is lower than a predetermined threshold value.

12. The server monitoring method according to claim 7, further comprising:
executing construction of a predetermined model;
receiving a request to construct a model from an application executed on the virtual machine/container; wherein
construction of the model is executed on the basis of the data held in a data store in which data necessary for constructing the model is collected and the collected data is held; and
shortening a collection interval of data with respect to the physical server that executes the application and increases the frequency of collection in a case where the number of pieces of data is insufficient or accuracy requirements for the data are not satisfied in the construction of the model.
